(19) United States
(12) Patent Application Publication
(10) Pub. No.: US 2016/0140228 A1
(43) Pub. Date: May 19, 2016

(54) REFORMATTING QUERIES FOR SEARCH ENGINES AND DATA REPOSITORIES

(71) Applicant: Google Inc., (US)

(72) Inventors: Tal Cohen, Atlit (IL); Yaacov Benisrael, Gibton (IL)

(73) Assignee: Google Inc., Mountain View, CA (US)

(21) Appl. No.: 13/778,379

(22) Filed: Feb. 27, 2013

(51) Int. Cl. G06F 17/30

(52) U.S. Cl. CPC G06F 17/30864

(57) ABSTRACT

The specification relates to providing a reformatted search query to a specific back end search engine or data repository. The search query is reformatted by identifying a domain of a search query. Based on the domain, a specific back end search engine or data repository associated with the domain is chosen to receive the reformatted query. The reformatting of the query is performed using a set of rules for the chosen back-end server. The reformatted query is sent to the at least one back-end server.

### BACKGROUND

The subject matter described herein relates to providing search results in response to search queries. A search engine receives search queries, for example, from one or more input sources, e.g., a client device, a server or any device that may submit a query and returns search results responsive to the queries. As another example, the search engine can receive queries from and return search results to a computing resource, such as another search engine.

The search engine can identify resources responsive to a search query, generate search results with information about the resources, and provide search results in response to the query. Examples of resources include, e.g., documents, web pages, videos, books, sound files, etc. Other types of search results can also be provided, for example, answers to questions posed by the user, or a summary of information responsive to the user's query.

### SUMMARY

Various user interfaces collect queries from users in different forms and collect answers from different sources. For example, personal assistants in mobile phones collect queries by voice input, and collect data in response from search engines or data repositories. The subject matter described herein reformats received freeform input queries. In other words, a natural-language query can be transformed into a search-engine-friendly query.

In one implementation, the methods comprise the steps of identifying a domain of a search query; determining at least one search system associated with the domain of the search query; reformatting the search query based on a set of rules for the one search system; and sending the reformatted query to the search system. Implementations of the subject matter include corresponding systems, apparatus, and computer programs, configured to perform the actions of the methods, encoded on computer storage devices.

These and other implementations can each include one or more of the following features. The method can include rewriting the search query based on a rewrite engine. The method can also include recognizing search patterns from the search query; and rewriting the search query based on the search patterns. Additionally, the method can include identifying language conversions from the search query; and rewriting the search query based on the language conversions.

The method can also include receiving results from the at least one search system; formatting the results; providing the formatted results; and presenting the formatted results either visually and/or auditorily.

In another implementation, a system can comprise one or more processors and one or more computer-readable storage mediums containing instructions configured to cause the one or more processors to perform operations. The operations can include: identifying a domain of a search query; determining at least one search system associated with the domain of the search query; reformatting the search query based on a set of rules associated with for the at least one search system; and sending the reformatted query to the at least one search system.

In another implementation, a computer-program product can be tangibly embodied in a machine-readable storage medium and include instructions configured to cause a data processing apparatus to: identify a domain of a search query; determine at least one search system associated with the domain of the search query; reformat the search query based on a set of rules for the at least one search system; and send the reformatted query to the at least one search system.

One or more of the implementations of the subject matter described herein may provide one or more of the following advantages. The subject matter described herein presents search engine specific queries to back-ends and repositories providing for accurate search results. The disclosed technology also has the ability to synchronize a database for patterns; map domain types to a particular search engine and optimize query searches in order to receive more accurate search results, as will be described more fully below.

### BRIEF DESCRIPTION OF THE DRAWINGS

FIG. 1 is a block diagram of an example of a search system used with the disclosed technology;

FIG. 2 is a flow chart showing an example process of reformatting a search query;

FIG. 3 is a flow chart showing an example process of identifying a domain of a search query;

FIGS. 4a-b are flow charts showing an example process of rewriting and reformatting a search query; and

FIG. 5 is a block diagram of an example of a system used with the disclosed technology.

### DETAILED DESCRIPTION

The subject matter described herein relates to providing search results in response to search queries. In some implementations, a system may receive an initial search query, e.g., a natural language search query and reformat this query into a search-engine-specific format. This can be accomplished by analyzing the initial search query to identify a domain, e.g., movie, sports, shopping, etc., associated with the search query. Using the identified domain, the system can determine which search engine(s) or data repository(ies) best handles the identified domain. Once determined, the system can access a set of rules for that specific search engine and reformat the natural language query specifically for that search engine.

When reformatting the query, the system can also use a rewrite engine to transform and optimize the initial search query into a query that can be better understood by any data repository or search engine, as will be described more fully below. This implementation of query optimization allows the search engine to return better and more accurate results.

The results can be received by a client side but, before returning the results, the results can be analyzed and formatted so that an intent of the initial search query can be accurately addressed.

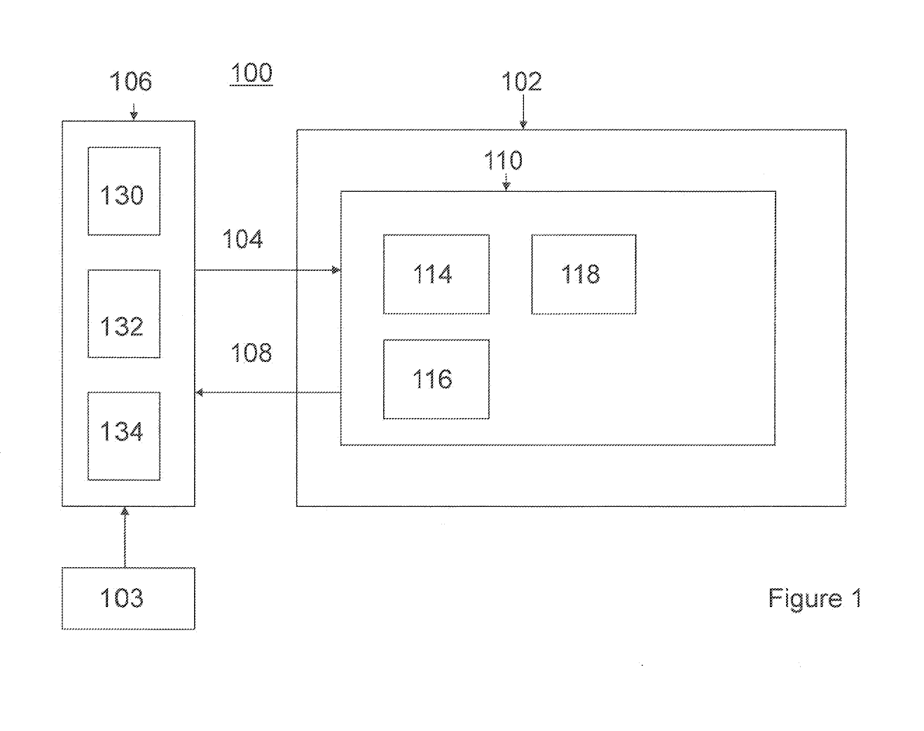

FIG. 1 illustrates an example search system 100 for providing a search result or ranked search results relevant to submitted queries as can be implemented in an internet, an intranet, or another client and server environment. The search system 100 is an example of an information retrieval system in which the systems, components, and techniques described below can be implemented. The search system 100 can be used, for example, to generate a single search result germane to the query or to generate ordered sets of search results.

A user 103 can interact with server 102 of the search system 100 through a client device 106. For example, the client device 106 can be a computer coupled to the server side 102 through a local area network (LAN) or wide area network (WAN), e.g., the Internet. In some implementations, the server 102 and the client device 106 can be one machine. For example, a user 103 can install a desktop search application on the client device 106. The client device 106 will generally include a random access memory (RAM) 130 and a processor 132.

The server 102 can include a search engine 110. The server 102 responds to a query 104 by generating search results 108, which are transmitted through the network to the client device 106 in a form that can be presented to the user, e.g., a search results web page to be displayed in a web browser running on the client device 106.

When the query 104 is received by the search engine 110, the search engine 110 identifies resources that match the query 104. The search engine 110 may also identify a particular “snippet” or section of each resource that is relevant to the query or of the highest ranked resources that are relevant to the query. The server 102 will generally include: (1) an indexing engine 114 that indexes resources, e.g., web pages, images, or news articles on the Internet found in a corpus, e.g., a collection or repository of content, (2) an index database 118 that stores the index information, and (3) a ranking engine 116, or other software, to rank the resources that match the query 104. The indexing engine 114 can index information using traditional techniques.

If a search engine receives a complex query, e.g. a natural language query asking a specific question and the search engine sends the query to outside databases and data repositories in order to obtain the results, before sending the query, the disclosed technology can reformat these queries so that a query received by one system can be reformatted to an optimized query format of another system. This is accomplished by taking an initial search query, for example, a natural language query, and obtaining the basic domain of the query. In other words, the domain of the query can be the subject area of the query, e.g., movies, sports, dictionary, etc. Based on the domain, a reformat engine can determine which back-end server to send the query to and reformat the initial query so that the back-end search system or data repository may better utilize the user's query.

In some implementations, more than one back-end server can be chosen for a query. If more than one back-end server is queried, results may be returned on first come basis or the results can be a blend of the returned results, as will be more fully described below.

For example, if a client device receives a natural language query of: “what's the name of the guys who signed constitution?”, the disclosed technology can use a reformat engine on the client side or the server side to reformat the initial search query in a way that is search engine or data repository specific. So, “what's the name of the guys who signed constitution” can be reformatted to be sent to a particular data repository or search engine and structured specifically for that repository, e.g., the query can be sent to a specific data repository as [United States Constitution: signers]. This query can now be handled by the data repository in an efficient manner.

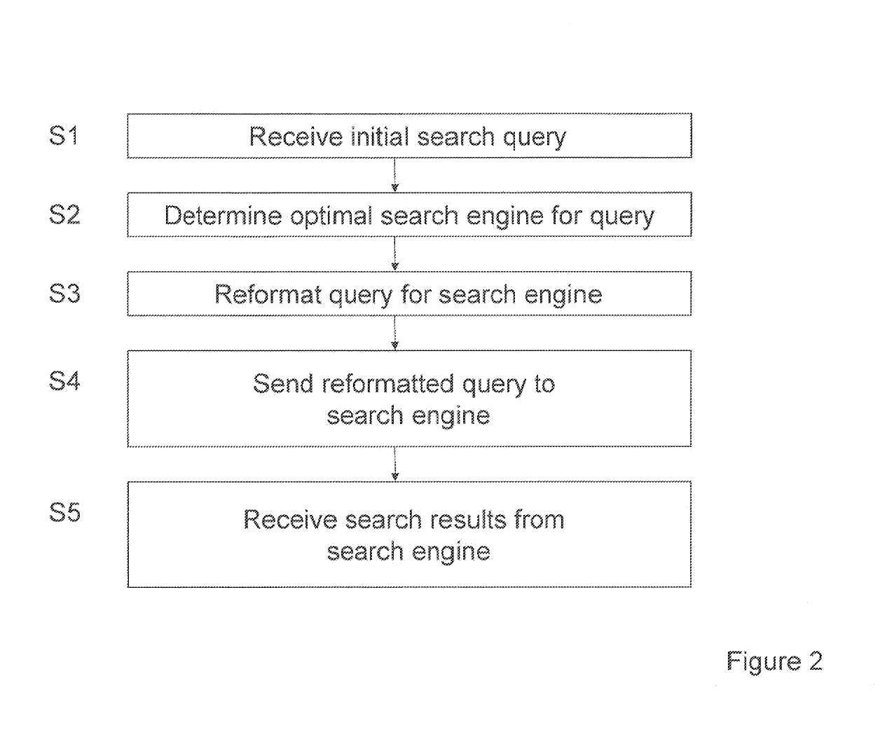

As shown in FIG. 2, a client device can receive a query from a user of the device (Step S1). The query is processed by a reformat engine (Step S2). The reformat engine can be an engine operating independently or may be part of a rewrite engine, as described more fully below. The reformat engine will reformat the query catered to a specific search engine (Step S3) and send the reformatted query to the specific search engine within the search system (Step S4). The search engine will return results to the client side (Step S5). Query reformatting can be done either at the client side e.g., desktops, laptops, smart phones, tablets and any other type of client device or at the server side, e.g., search engine, data repository, etc. Reformatting at the client side allows the client to extend the abilities of any search engine at the interface level, that is, sending a standard query, without any cooperation from the search engine. If done on the server side, the reformatting can take place early in the search process, so that all other stages benefit from it.

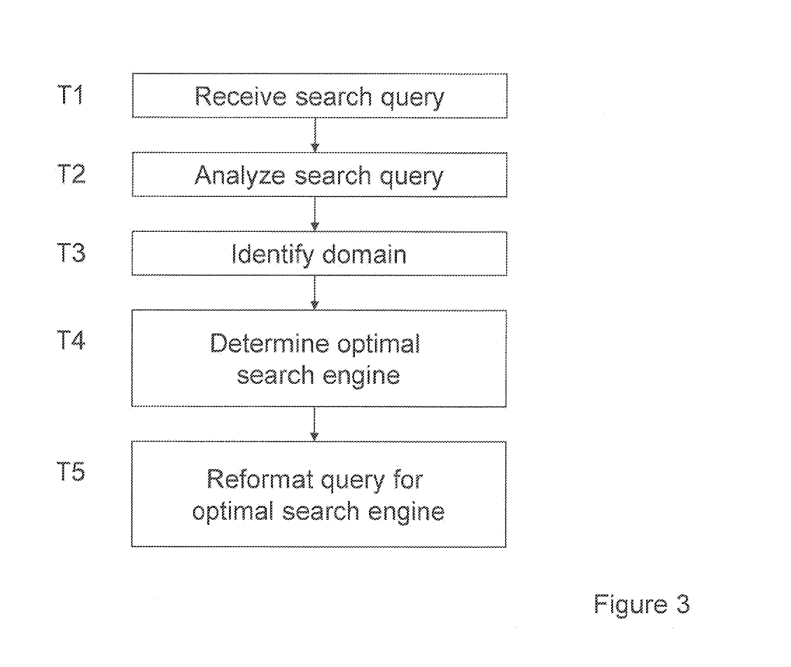

As shown in FIG. 3, the reformat engine receives a search query, e.g., a natural language query (Step T1). The reformat engine analyzes the search query (Step T2) and identifies a domain associated with the search query (Step T3). For example, the domain can be identified by identifying an entity of the query and associating the entity with a particular domain. That is, an entity identifier module can analyze a query and identify an entity using a data repository that contains known entities. If an entity is identified within a repository, the entity identifier can use the data repository to map the entity to metadata indexing each entity to a domain, e.g., “New York Yankees” can be mapped or indexed to a domain of “sports.” From this index, a domain for the query can be identified. The identified domain is used to determine a particular search engine to which the query will be sent (Step T4). The particular search engine may be determined using an index of search engines that handles each domain and this index can be stored in a data repository along with a set of rules for each search engine. The query is reformatted according to a set of rules specific to the particular search engine (Step T5). The domain can be identified using different techniques and at different times during the reformat process depending on the process implemented, as will be described below.

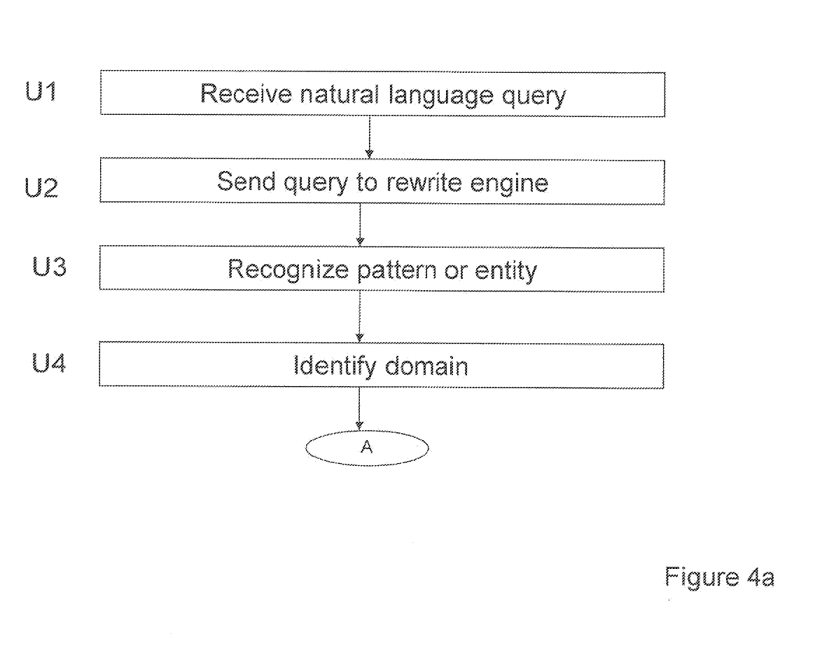

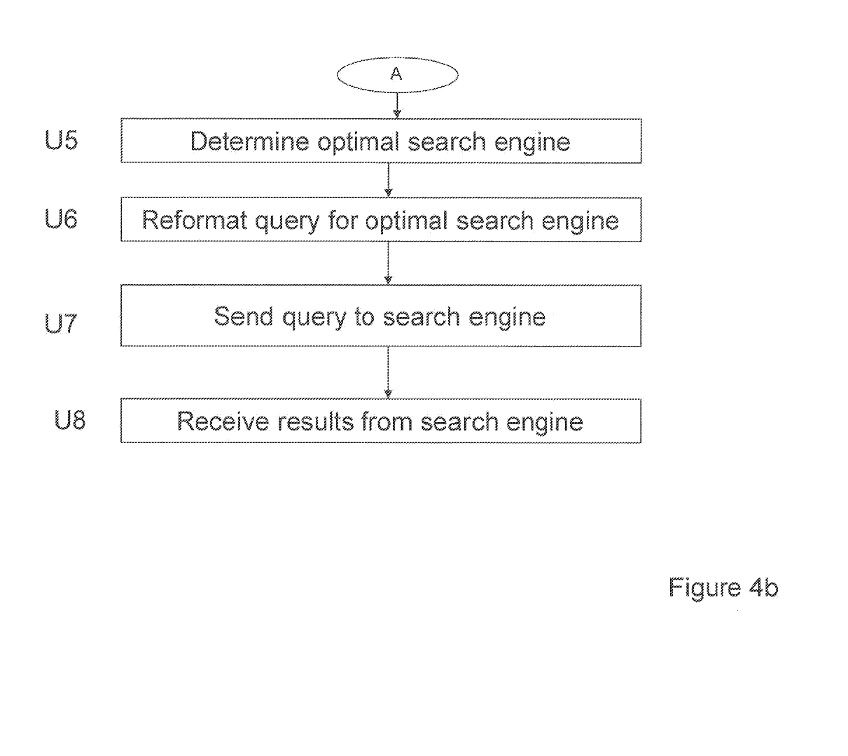

In one implementation, as shown in FIGS. 4a-b, the system receives a natural language query (Step U1). The system sends the query to a rewrite engine, the rewrite engine can include a reformat engine, as described above, or the reformatting may be performed by a reformat engine operating independently from the rewrite engine (Step U2).

The rewrite engine can convert the natural language query into a search-words query. That is, search engines usually search based on words not questions. So, to reformat the natural language query, the reformat engine passes the query through a rewrite engine. The rewrite engine can be built using a number of methods, e.g., machine learning techniques, results of control group studies, analysis of previous searches, analysis of previous refinement of searches, etc. The rewrite engine can be static or updated regularly. Additionally, feedback information, like click-through-rate and time spent on results can be used to improve the rewriting engine.

One implementation of the rewrite engine can remove natural language annotations, stop words and other elements of speech from the query. All language that is used to form a question can be removed from the query. This removal makes the probability of getting a correct answer to a query much higher. For example: [What is the price of XYZ stock?] can be reformatted to [price: XYZ: stock] or [Tell me about the movie the Magnificent Seven] to [tell me about: movie: Magnificent Seven].

The rewrite engine can also replace speaking language with direct language. For example, replace natural language idiom with domain idiom, e.g., [Please show me the way from San Francisco to Mountain View] reformatted to [Directions: San Francisco>Mountain View] or [How good is the book the Hobbit?] to [The Hobbit: reviews]. In order to replace speaking language in such a manner, a repository containing common language conversions can be formed. These language conversions can be pre-learned and stored in data repositories. These language conversions may be search engine specific, e.g., “show me the way” may be converted to “directions” for one search engine but “navigate” in another search engine depending on the search rules and structure.

The rewrite engine can replace natural language terms with client device knowledge, e.g., location, date and time are sometimes implicit when using a natural language query. The rewrite engine can supplement the query with known data, e.g., location data (GPS). For example, if a client device knows the location and time, it can replace implicit references with explicit ones. For example, a natural language of [What is the weather tomorrow?] can be reformatted to, assuming a user is in Mountain View, Calif. on Sep. 15, 2012 at 1:00 PM PST, [weather forecast: Mountain View, Calif.; Sep. 16, 2012] or [Where can I shop for boots nearby] to [boots: shopping: Mountain View, Calif.].

The rewrite engine can use refinement information from other users to reformat the query. Refinement information can be common refinements a user may perform to a query. For example, a user may query “dogs for sale” and then refine the query by submitting a second query for “German Shepherd for sale” and then further refine the query by submitting a third query for “German Shepherd for sale in Mountain View”. These common refinements chains can be stored in a data repository. Now when a simple query is used that returns too many results, the refinement information can be utilized to replace the simple query with a more refined search term, e.g., a user looking for a hot cup of coffee may use a query of “Closest coffee” but the search results for that query may return results that include grocery stores that sell coffee beans and grinds. However, through refinement analysis it may be found that a common refinement for “closest coffee” is “closest coffee house.” Replacing the initial query with this refinement limits searches to only coffee houses and more desired search results can be obtained.

The rewrite engine can use a trained learner to extract entities, actions and attributes from a query. When reformatting the query, the system can use the identified entity, actions or attributes so that the reformatted query is provided to the search engines, on a server side, in an optimized format, e.g., [entity, action, attribute]. This format provides for the search engine to return accurate results. Any machine learning algorithm can be used using previous searches and search refinements as the training data.

The rewrite engine can use an extracted entity to obtain proper entity name. From the example used above, the query of [What is the price of XYZ stock?] can be reformatted to [XYZ: stock price]. The rewrite engine can identify that XYZ is the entity for the query. The rewrite engine can look the entity up in a repository to ensure that the entity is listed under its proper name. For example, if the system receives a query of [Did the Yanks win last night?], and this was reformatted to [Yanks: statistics: Jun. 2, 2012]. The entity “Yanks” would be referenced in the repository and a result of New York Yankees may be found. The query may than be updated to [New York Yankees: statistics: Jun. 2, 2012].

The rewrite engine can recognize established patterns, e.g., [entity: specific attribute]. Some example patterns are: [company name: stock price]; [company name: market cap]; [movie: release date]; [mountain: height]; [person: birth place], [directions: start point: end point]. These patterns are pre-learned and stored in data repositories and may be mapped to a domain index. The patterns can be established by control groups, past searches, past intents and formatted manually as common queries with relevant results form patterns over time.

In some implementations, the rewrite engine can recognize a pattern or an entity, as described above. (Step U3). These common patterns or entities can be used to find a query domain, e.g. movie, books, shopping, stocks, restaurants, map, etc. (Step U4). For example, the query of “Who played Vincent Vega in Pulp Fiction” can be found to have a pattern of [actor; character: movie] and can therefore be identified as in a movie domain or an entity of “Pulp Fiction” can be indexed to a domain of movie.

Using the identified domain, the system determines which search engine(s) or data repository(ies) best handles the identified domain (Step U5). As described above, the system can access a set of rules for that identified search engine and reformat the natural language query so that it is optimized specifically for that search engine (Step U6). These rules can be contained in a data repository for the back-end servers. Rules can be made manually, e.g., learning a back-end and how to optimize, or automatically, e.g., get rules directly from back-end server or a help center associated with the back-end server.

The client device sends the rewritten and reformatted query to a specific backend server or several specific back-end servers (Step U7). In some implementations, instead of sending queries to multiple back-ends, the client can send multiple queries to a generic backend with site restrictions, e.g. [magnificent seven: reviews: movie.com]. These back-end servers perform the search and return results to the client device (Step U8).

The client device can aggregate the search results and/or arrange the search results as accurate and relevant answers to the initial query. In some implementations, several queries can be sent to the several back-end servers in parallel, each one rewritten in a different way for a specific back-end as described above. Each set of results can be merged at the client side for more accurate or robust search results. In other words, once the search results are obtained, the results will be sent back to the client side. Before returning results to a user, the results may be analyzed using an identified intent of the natural language query. This intent can be identified using the common patterns described above. The results can be tabulated with this intent so that the search result is an accurate and relevant answer to the initial query.

Below is an example of a query reformat:

Client device receives an initial query of: “Are the Lakers playing tonight?”. The query is sent to reformat engine. Stop words are removed from query, e.g. “are” and “the”. This formats the query to “Lakers playing tonight”. Reformat engine recognizes “Lakers” as entity, “playing” as action and “tonight” as attribute. Known language conversion is found and “Playing tonight” is changed to “schedule.” “Tonight” is recognized as today's date. “Lakers” is mapped to an entity title of “Los Angeles Lakers.” A pattern was recognized as [sports team: schedule: date]. The query is rewritten to [Los Angeles Lakers: schedule: Nov. 20, 2012].

The domain is identified as sports. The reformat engine determines which back-end can best handle a sports query. Sportsweb.com is determined to be best search engine suited for this search. The reformat engine reformats the rewritten query [Los Angeles Lakers: schedule: Nov. 20, 2012] based on rules for sportsweb.com. Rules for sports web may include format of date and abbreviated name of entity, e.g., the reformatted query may be [LA Lakers: schedule: 11.20.2012]. This query is then sent to sportsweb.com. Sportsweb.com returns result. The reformat engine or some other client engine can use an identified intent of the search query with data retrieved during the search. Based on the analysis, a relevant and accurate result is produced and sent to a client device. For example, the result can be presented to a user of a client device as “LA Lakers v NY Knicks, tonight at 7:30 PM PST.” The result may be a visual, audio or some other format informing the user the time of game.

In some implementations, the query reformat may be personalized to a user's device, e.g., a name from a contact list. In one example, the device can check to see if an entity exists on a user's device before sending the query to a back-end server. If private data is used, the data may not be transmitted to a server unless requested.

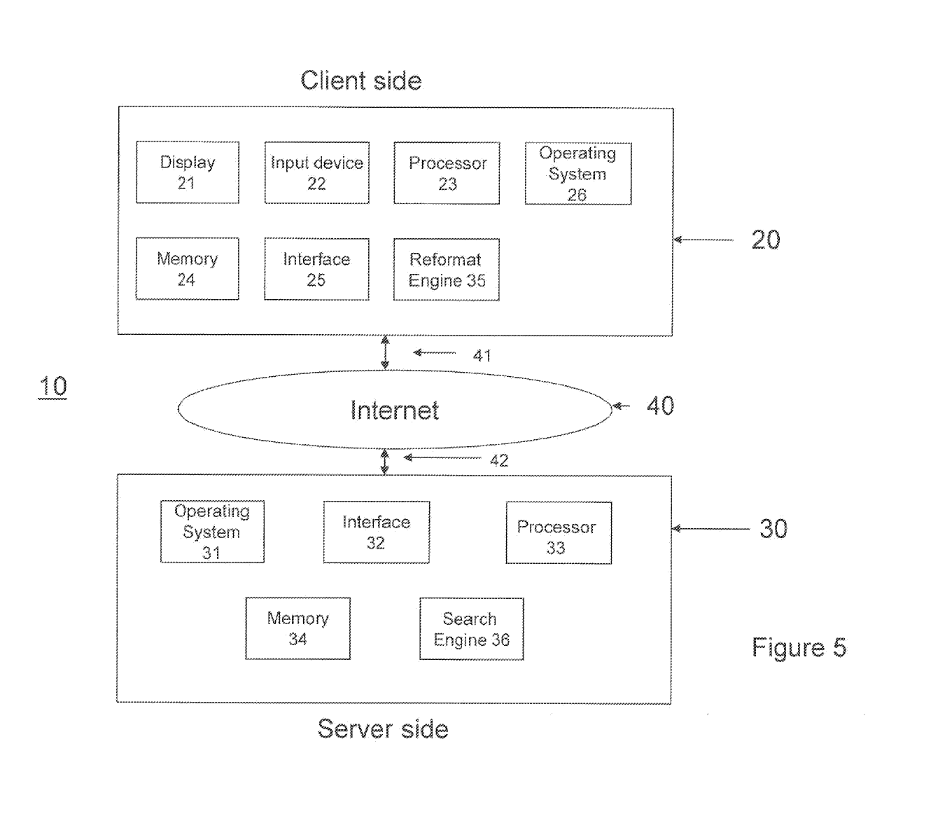

FIG. 5 is a schematic diagram of an example of a search system 10. The system 10 includes one or more processors 23, 33, one or more display devices 21, e.g., CRT, LCD, one or more interfaces 25, 32, input devices 22, e.g., keyboard, mouse, touch screen, etc., a reformat engine 35, a search engine 36, and one or more computer-readable mediums 24, 34. These components exchange communications and data using one or more buses 41, 42, e.g., EISA, PCI, PCI Express, etc.

The term “computer-readable medium” refers to any non-transitory medium 24, 34 that participates in providing instructions to processors 23, 33 for execution. The computer-readable mediums 24, 34 further include operating systems 26, 31 with network communication code, reformatting code, searching code, result grouping code, result presentation code, and other program code.

The operating systems 26, 31 can be multi-user, multiprocessing, multitasking, multithreading, real-time and the like. The operating systems 26, 31 may perform basic tasks, including but not limited to: recognizing input from input devices 22; sending output to display devices 21; keeping track of files and directories on computer-readable mediums 24, 34, e.g., memory or a storage device; controlling peripheral devices, e.g., disk drives, printers, etc.; and managing traffic on the one or more buses 41, 42.

The network communications code may include various components for establishing and maintaining network connections, e.g., software for implementing communication protocols, e.g., TCP/IP, HTTP, Ethernet, etc.

The reformatting code may provide various software components for performing the various functions of rewriting and reformatting submitted queries. The searching code may provide various software components for performing the various functions of searching data repositories and/or data indexes for information related to the search queries.

The result grouping code may provide various software components for performing the various functions for grouping search results, which can include clustering or otherwise assessing similarity among results. The results presentation code may also provide various software components for performing the various functions for presenting and modifying a user interface showing the search results.

Moreover, as will be appreciated, in some implementations, the system of FIG. 5 is split into a client-server environment communicatively connected over the internet 40 with connectors 41, 42, where one or more server computers 30 include hardware as shown in FIG. 5 and also the result grouping code, code for searching and indexing data on a computer network, and code for generating results for submitted queries, and where one or more client computers 20 include hardware as shown in FIG. 5 and also the reformatting code and the results presentation code, which can be pre-installed or delivered in response to a query, e.g., an HTML page with the code included therein for interpreting and rendering by a browser program.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on mobile phones, smart phones, tablets, personal digital assistants, and computers having display devices, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, tactile feedback, etc.; and input from the user can be received in any form, including acoustic, speech, tactile input, etc. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network, e.g., the Internet, and peer-to-peer networks, e.g., ad hoc peer-to-peer networks.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page to a client device, e.g., for purposes of displaying data to and receiving user input from a user interacting with the client device. Data generated at the client device, e.g., a result of the user interaction can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. In some cases, the actions recited in the claims can be performed in a different order and still achieve desirable results. Moreover, the separation of various system components in the embodiments described above should not be understood as requiring such separation in all embodiments, and it should be understood that the described program components and systems can generally be integrated together in a single software product or packaged into multiple software products.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising the steps of:
receiving, from a client device, a search query;
determining, from the search query, a predefined pattern satisfied by the search query, the pattern being one of a plurality of predefined patterns and including an entity and one or more attributes, and wherein the pattern is determined based on one or more terms of the search query;
mapping the determined pattern to a particular domain using an index relating particular patterns to domains, wherein the particular domain indicates a subject area of the search query;
determining a particular search engine from a plurality of distinct search engines based on the particular domain, wherein each search engine is associated with one or more domains;
reformatting the search query specifically for the determined search engine based on a set of rules of the determined search engine;
sending the reformatted search query to the determined search engine;
receiving, from the determined search engine, one or more search results in response to the search query;
analyzing the one or more search results using the determined pattern from the search query to generate a single result that is relevant to the search query; and
providing the single result to the client device.

2. The method of claim 1 further comprising the step of:
recognizing a plurality of refinement information; and
rewriting the search query based on the refinement information.

3. The method of claim 1 further comprising the step of:
rewriting the search query based on the determined pattern.

4. The method of claim 1 further comprising the step of:
identifying language conversions from the search query; and
rewriting the search query based on the language conversions.

5. The method of claim 1 further comprising the step of:
formatting the single result.

6. The method of claim 5, wherein the single result is provided to the client device in an audio format.

7. A system comprising:
one or more processors;
one or more computer-readable storage mediums containing instructions configured to cause the one or more processors to perform operations including:
receiving, from a client device, a search query;
determining, from the search query, a predefined pattern satisfied by the search query, the pattern being one of a plurality of predefined patterns and including an entity and one or more attributes, and wherein the pattern is determined based on one or more terms of the search query;
mapping the determined pattern to a particular domain using an index relating particular patterns to domains, wherein the particular domain indicates a subject area of the search query;
determining a particular search engine from a plurality of distinct search engines based on the particular domain, wherein each search engine is associated with one or more domains;
reformatting the search query specifically for the determined search engine based on a set of rules of the determined search engine; and
sending the reformatted search query to the determined search engine;
receiving, from the determined search engine, one or more search results in response to the search query;
analyzing the one or more search results using the determined pattern from the search query to generate a single result that is relevant to the search query; and
providing the single result to the client device.

8. The system of claim 7, wherein the operations further comprises the steps of:
recognizing a plurality of refinement information; and
rewriting the search query based on the refinement information.

9. The system of claim 7, wherein the operations further comprises the step of:
rewriting the search query based on the determined pattern.

10. The system of claim 7, wherein the operations further comprises the steps of:
identifying language conversions from the search query; and
rewriting the search query based on the language conversions.

11. The system of claim 7, wherein the operations further comprises the step of:
formatting the single result.

12. The system of claim 11, wherein the single result is provided to the client device in an audio format.

13. A computer-program product, the product tangibly embodied in a non-transitory machine-readable storage medium, including instructions configured to cause a data processing apparatus to:
receive, from a client device, a search query;
determine, from the search query, a predefined pattern satisfied by the search query, the pattern being one of a plurality of predefined patterns and including an entity and one or more attributes, and wherein the pattern is determined based on one or more terms of the search query;
map the determined pattern to a particular domain using an index relating particular patterns to domains, wherein the particular domain indicates a subject area of the search query;
determine a particular search engine from a plurality of distinct search engines based on the particular domain, wherein each search engine is associated with one or more domains;
reformat the search query specifically for the determined search engine based on a set of rules of the determined search engine;
send the reformatted search query to the determined search engine;
receive, from the determined search engine, one or more search results in response to the search query;
analyze the one or more search results using the determined pattern from the search query to generate a single result that is relevant to the search query; and
provide the single result to the client device.

14. The computer-program product of claim 13 further including instructions configured to cause the data processing apparatus to:
recognizing a plurality of refinement information; and
rewrite the search query based on the refinement information.

15. The computer-program product of claim 13 further including instructions configured to cause the data processing apparatus to:
rewrite the search query based on the determined pattern.

16. The computer-program product of claim 13 further including instructions configured to cause the data processing apparatus to:
identify language conversions from the search query; and
rewrite the search query based on the language conversions.

17. The computer-program product of claim 13 further including instructions configured to cause the data processing apparatus to:
format the single result.

18. The computer-program product of claim 17, wherein the single result is provided to the client device in an audio format.

19. The method of claim 1 further comprising the step of:
associating the determined entity with a proper name; and
rewriting the search query based on the proper name.

20. The method of claim 3, wherein determining the pattern based on the context of the search query comprises the step of:
mapping the pattern to a domain index.
